(19) United States
(12) Patent Application Publication
(10) Pub. No.: US 2006/0251904 A1
(43) Pub. Date: Nov. 9, 2006

(54) Hybrid optical component

(76) Inventor: Mark A. Ealey, Littleton, MA (US)

Correspondence Address: Iandiorio & Teska, 260 Bear Hill Road, Waltham, MA, 02451-1018, US

(21) Appl. No.: 11/124,714

(22) Filed: May 6, 2005

(51) Int. Cl. B32B 17/00; B32B 15/00; B32B 27/36

(52) U.S. Cl. 428/426; 428/480; 428/457

(57) ABSTRACT

A hybrid optical component includes a substrate including a mounting surface and a replicated optical surface mounted on the mounting surface.

### FIELD OF THE INVENTION

This invention relates to a hybrid optical component, and more particularly to such a hybrid optical component which has an excellent optic figure and finish, is lightweight and can be fabricated by replication.

### BACKGROUND OF THE INVENTION

Light weight optical components such as mirrors are made of glass, beryllium, Ceraform and other materials such as SiC or metal. Glass components are often made by machining away a glass blank to a lightweight structure. The resulting glass optical component typically has a modulus of elasticity of 10 msi with weight of 20-40 Kg/m² Components of beryllium have the same general characteristics but with modulus of elasticity of 70 msi. Ceraform SiC results in a lightweight near net shape with approximately 0.1% shrinkage and a modulus of elasticity of 50 msi. Ceraform SiC is a directly polishable version of siliconized silicon carbide that can be near net shape formed and is obtainable from Xinetics, Inc, Devens, Mass. However, these devices still require significant cost and time to finish and polish and cannot practically approach the finish possible with glass.

### BRIEF SUMMARY OF THE INVENTION

It is therefore an object of this invention to provide an improved hybrid optical component.

It is a further object of this invention to provide such provide an improved hybrid optical component which has excellent optical finish and figure yet is easier and faster to make and can be easily replicated too.

The invention results from the realization that an improved optical component, which has a high quality optical finish and figure, and stiffness and which can be replicated for manufacture, can be achieved with a substrate having a mounting surface on which is mounted a replicated optical surface.

The subject invention, however, in other embodiments, need not achieve all these objectives and the claims hereof should not be limited to structures or methods capable of achieving these objectives.

This invention features a hybrid optical component including a substrate having a mounting surface and a replicated optical surface mounted on the mounting surface.

In a preferred embodiment the replicated optical surface may include a nanolaminate, glass, or Mylar film. The replicated optical surface may include a nanolaminate made from zirconium-copper, Invar or Monel-titanium. The substrate may include glass, silicon carbide, beryllium, carbon fiber reinforced polymer, metal matrix composites, glass matrix composites, or carbon matrix composites. The replicated optical surface may be mounted by brazing, solder, diffusion bonding, or an adhesive. The adhesive may include a polymer such as an epoxy. The adhesive may include a particulate and the particulate may include fused silica

### BRIEF DESCRIPTION OF THE DRAWINGS

Other objects, features and advantages will occur to those skilled in the art from the following description of a preferred embodiment and the accompanying drawings, in which:

FIG. 1 is a three dimensional diagrammatic view of a hybrid optical component according to this invention;

FIG. 2 is a schematic side sectional view of the hybrid optical component of FIG. 1.

FIG. 3 is a three dimensional view of the other side of the a hybrid optical component of FIG. 1 showing the support structure;

FIG. 4 is a three-dimensional schematic view of a nanolaminate on a mandrel;

FIG. 5 is a three dimensional schematic view of the underside of a substrate;

FIG. 6 is a three dimensional schematic view of the mandrel borne nanolaminate on the table of a robot machine;

FIG. 7 is a three dimensional schematic view of the mandrel with the substrate of FIG. 2 supported above it on the arm of the robot machine in preparation for bonding;

FIG. 8 is a three dimensional schematic view of the bonded assembly of substrate, nanolaminate and mandrel according to this invention;

FIG. 9 is a three dimensional schematic view of a hybrid optical component according to this invention including the substrate bearing the nanolaminate released from the mandrel;

FIG. 10 is a graph of temperature vs. time from the bonding through release;

FIGS. 11-14 are schematic side elevational cross-sectional views showing the steps of applying the adhesive, squeezing out the adhesive, curing the adhesive and releasing the nanolaminate from the mandrel;

FIG. 15 is an enlarged schematic side elevational cross-sectional view of a portion of substrate-nanolaminate-mandrel assembly illustrating the adhesive; and

FIGS. 16A-E are three dimensional views of a portion of a robot machine showing the substrate as controlled by the robot arm with displacement dial meters for monitoring the adhesive gap/force.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

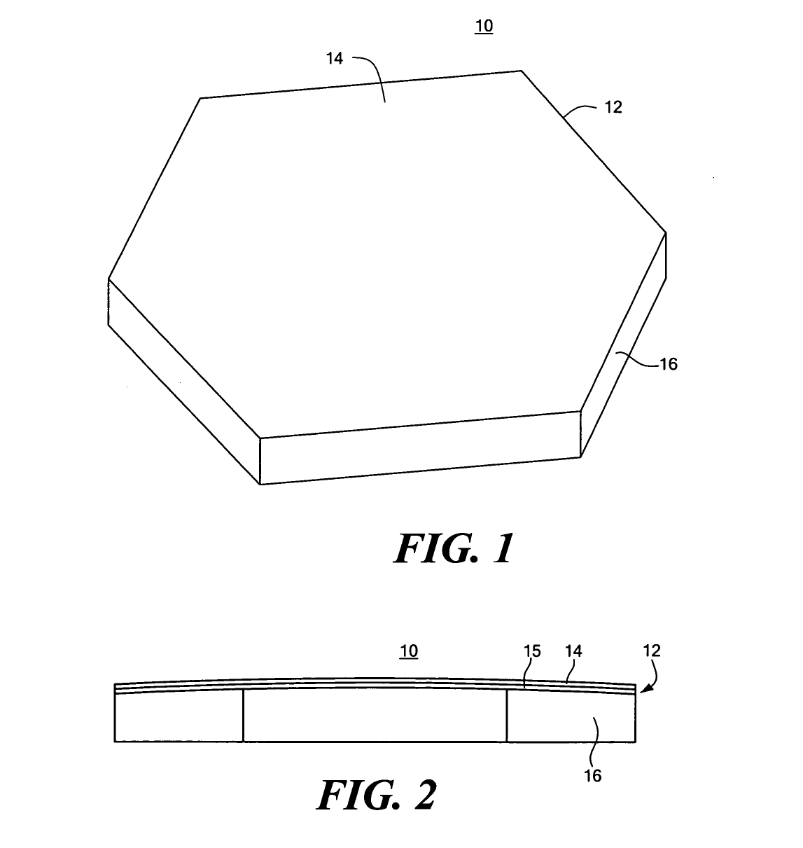

This invention features an hybrid optical component 10, FIG. 1, including substrate 12, typically silicon carbide or an equivalent, such as metal, glass, ceramic, polymer and components thereof including but not limited to Fused Silica, ULE, beryllium, Zerodur, A1 6061-T6, MMC 30% SiC, Be I-70. Be I-220-H, Cu OFC, Cu Glidcop, Invar 36, Super Invar, Molybdenum, Silicon, SiC HP alpha, SiC CVD beta SoC RB 30% Si, C/SiC, SS 304, SS 416, SS 17-4PH, Ti 6A14V, Gr/EP GY70x30, metal matrix composites, carbon matrix composites, glass matrix composites, and carbon fiber reinforced polymers having a replicated optical surface or film such as mirror surface 14 on one side joined to a support structure 16, on the other side. The replicated optical surface or film 14 may include glass, Mylar film, or a nanolaminate such as produced by Lawrence Livermore National Laboratory, see Nano-Laminates: A New Class of Materials for Aerospace Applications by Troy W. Barbee, Jr., Lawrence Livermore National Laboratory, Livermore, Calif. 94550-9234. These nanolaminates may be from one monolayer (0.2 nm) to hundreds or thousands of monolayers (25-100 microns) thick and are typically made from e.g. zirconium-copper, Invar, Monel titanium. They are generally made on a mandrel whose surface has been highly figured and finished so when the process is complete the nanolaminate surface is also highly figured and finished. Thus, this substrate no longer need have the surface ground or polished, because the actual optical finish, of much higher quality, is provided by the replicated surface, e.g. a nanolaminate.

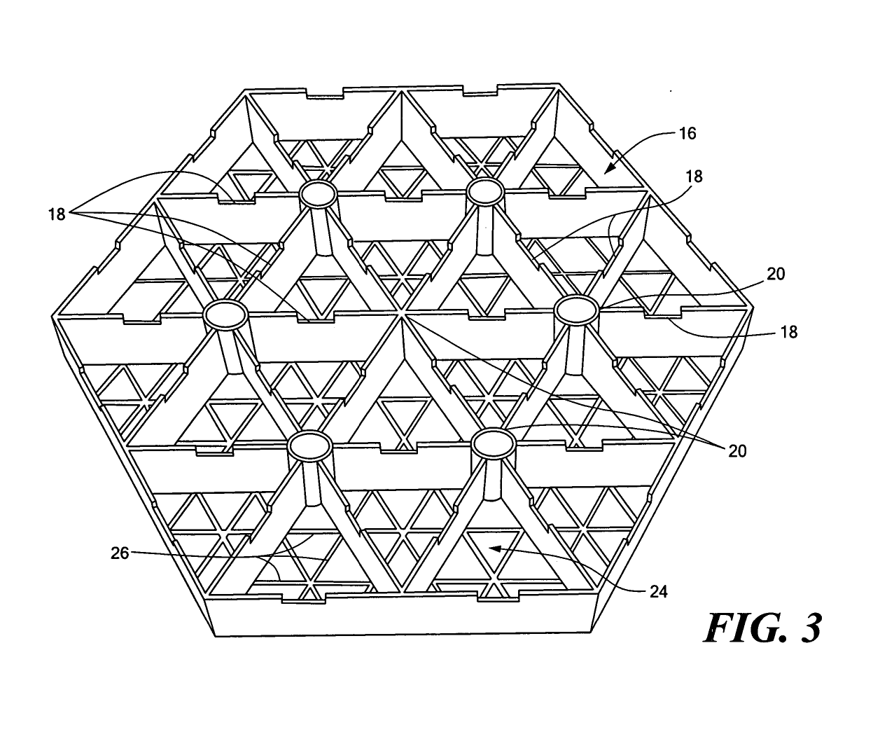

The construction of a hybrid optical component 10 according to one embodiment of this invention is shown in FIGS. 1 and 2, where replication film 14 is constituted by a nanolaminate attached to substrate 12 by some means 15. The attachment means 15 may be e.g. brazing, solder, diffusion bonding or other bonding such as an adhesive as hereinafter described by way of one example. The adhesive may include epoxies, phenolics, urethanes, anaerobics, acrylics, cyanoacrylates, silicones, polysulfides, elastomeric adhesives.

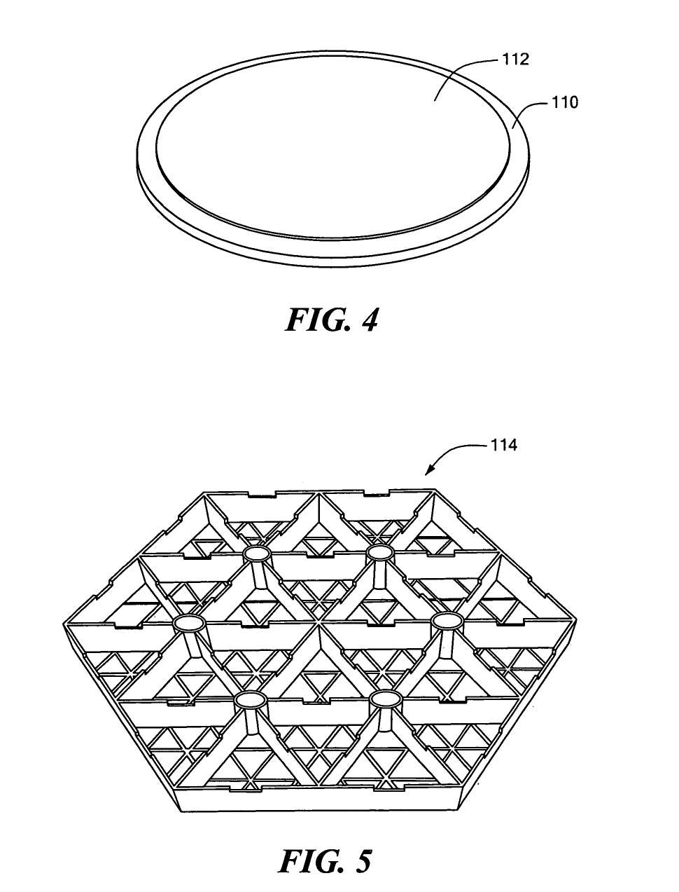

Substrate 12 may be solid as shown in FIGS. 1 and 2 or hollow or honeycombed as shown with support structure 16, FIG. 3, of substrate 12 including a plurality of major ribs 18, which intersect at a node 20 at the center of a zone of influence. The array of major ribs creates a honeycomb-like structure supporting back side 24 of surface 14 on which can be located cathedral ribs 26 for strengthening and further supporting surface 14.

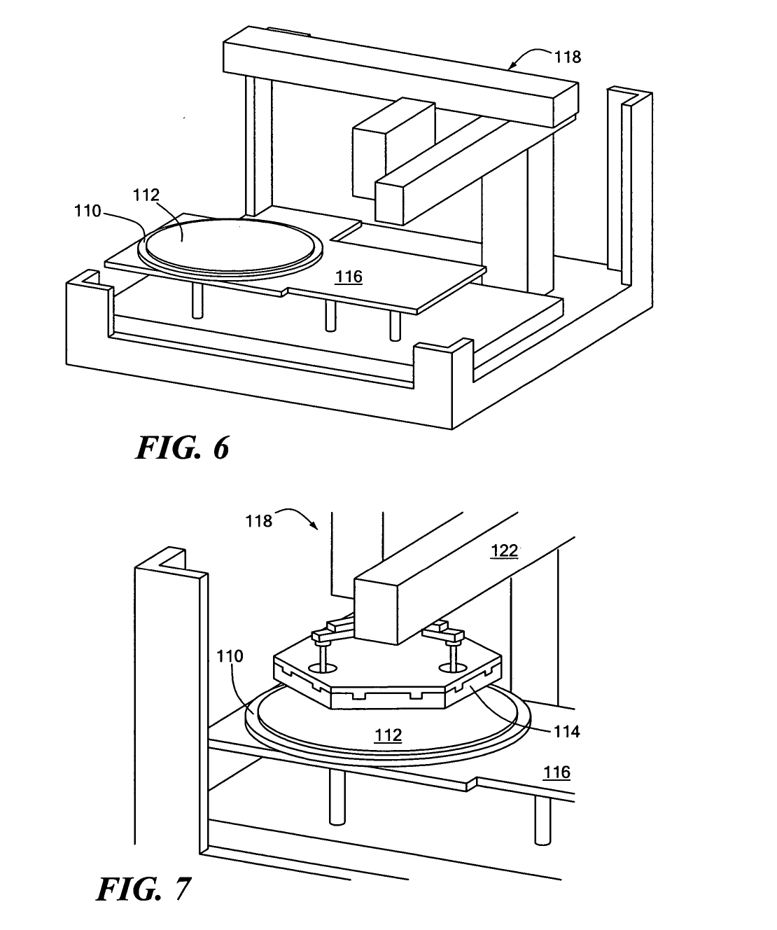

A method of making a hybrid optical component according to this invention particularly using a nanolaminate is described in FIGS. 4-16 following.

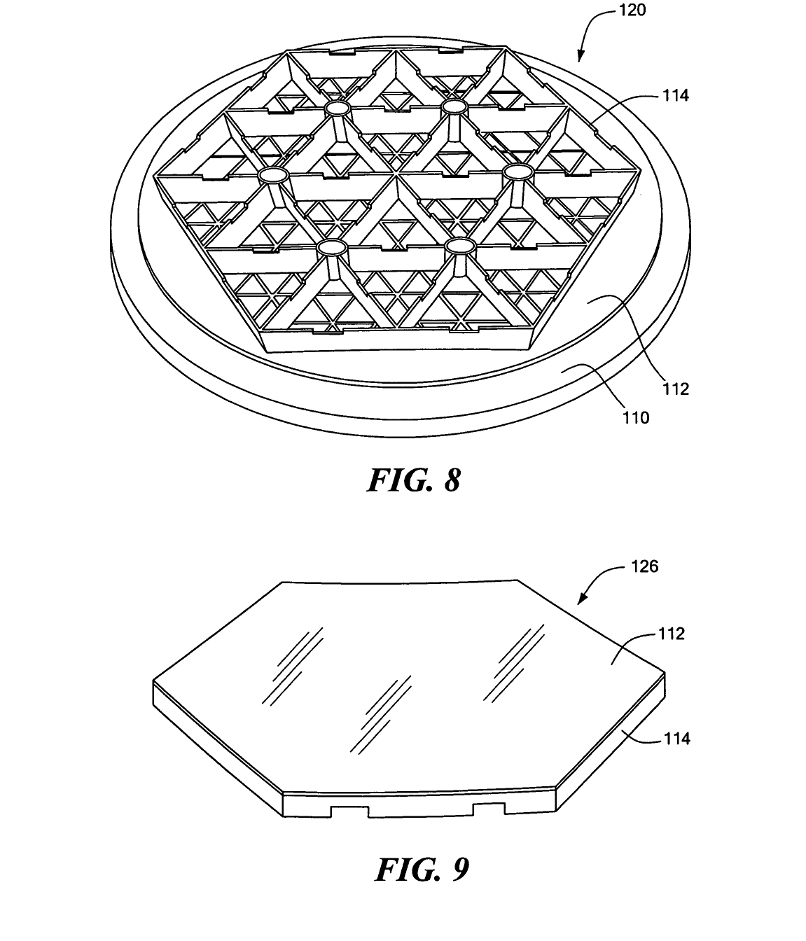

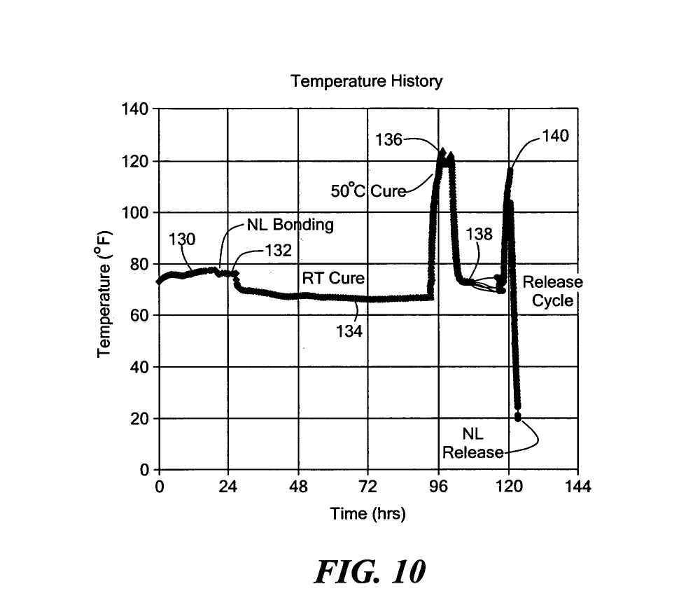

There is shown in FIG. 4 a mandrel 110 which contains on it a nanolaminate 112 made of, for example, zirconium-copper, Invar, Monel titanium which may be made or may be procured from, for example, Lawrence Livermore National Laboratory. Nanolaminate 112 may be attached to mandrel 110 by means of a parting layer, such as carbon. Substrate 114, FIG. 5, may as depicted in FIGS. 1, 2, 3, supra. Mandrel 110 with nanolaminate 112 is placed on the table 116, FIG. 6, of a robot machine 118 such as an A&M Saga 5x52 positioning machine.

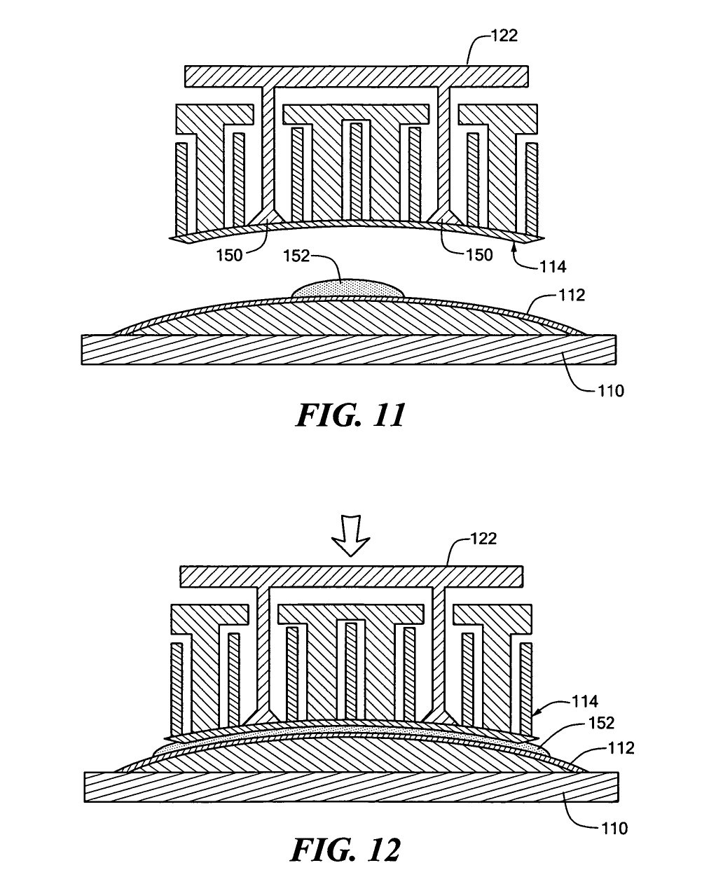

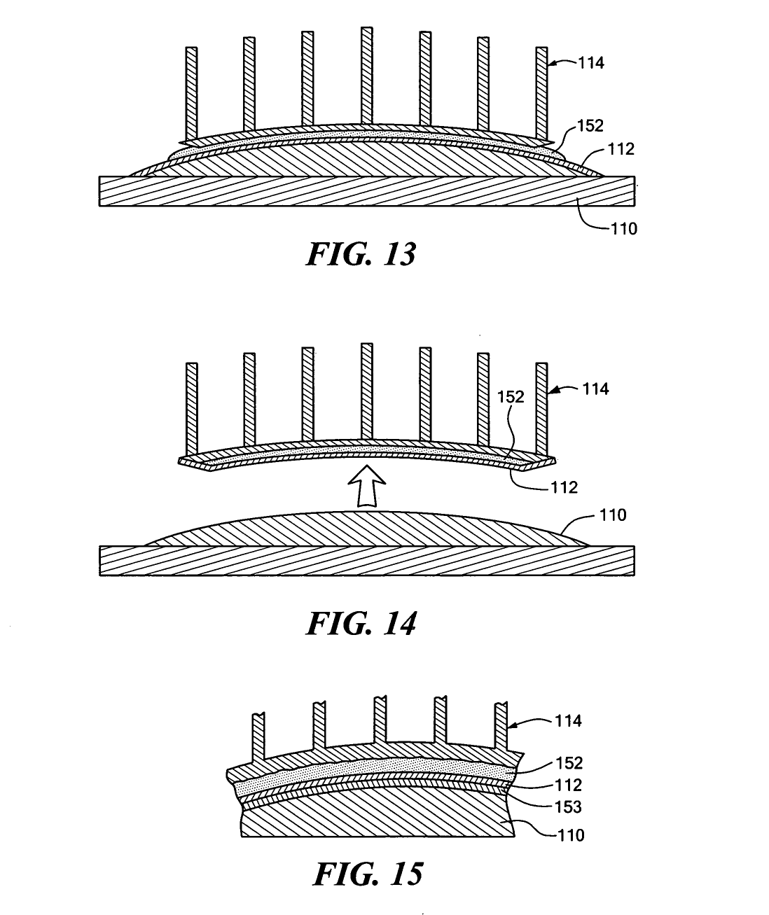

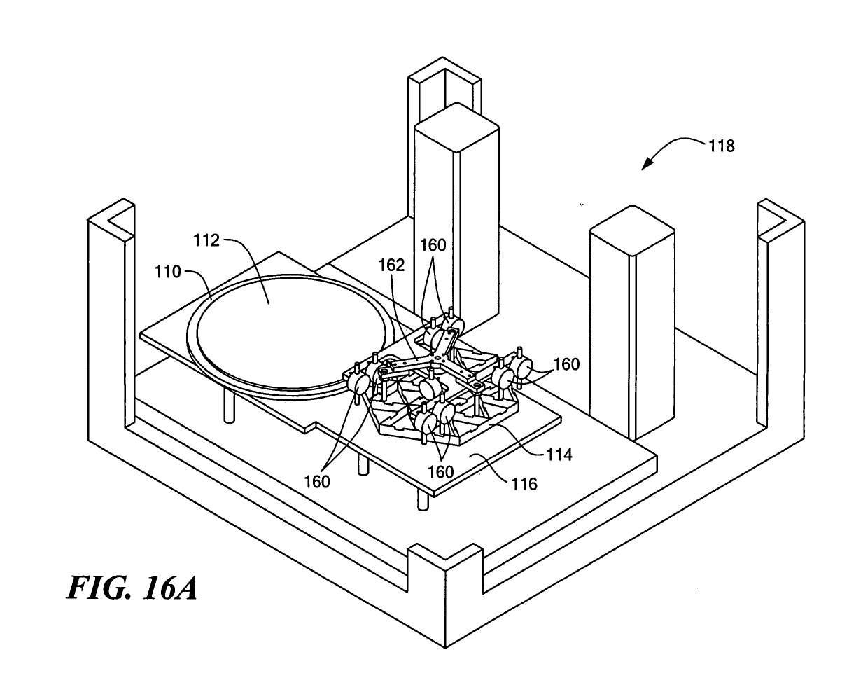

In accordance with this invention, the substrate 114, FIG. 7, is held suspended from the arm 122 of robot machine 118 over and aligned with nanolaminate 112 on mandrel 110. And the two are joined in a suitable way as described above but in this illustrated example bonding by adhesive is preferred. An adhesive is placed between the confronting surfaces of substrate 114 and nanolaminate 112, then the two parts are brought together, the adhesive is distributed over the face and bonding begins. After a period of curing at room temperature, the bonded assembly 120 is put into a temperature chamber where it is cycled, FIG. 8, first to a higher temperature, typically room temperature to 50° C. to complete the curing of the adhesive, typically an epoxy such as #301-2 made by Epoxy Technology Inc., Billerica, Mass. or a special order adhesive #52-180-1 made by Epoxy Technology, Inc. Billerica, Mass. After the curing is complete, the bonded assembly is brought down to room temperature then raised again to an elevated temperature, typically room temperature to 50° C. and then brought down to a reduced temperature, typically room temperature to −20° C. This temperature cycling induces thermal moments in the bonded assembly 120 which enables the nanolaminate to separate from the mandrel on which it was introduced but remain bonded by means of the adhesive to the substrate 114. The end product is a hybrid optical component, mirror 126, FIG. 9, which includes the substrate 114 with a nanolaminate 112 adhered to it. Although temperature cycling is disclosed as the separation technique in this explanation, this is not the only way of applying external energy to effect the separation. Acoustic energy; ultrasonic energy; radiant energy; electromagnetic, visible, r.f., microwave energy, mechanical energy can be applied to effect the separation. And the separation may be facilitated by initiating a critical flaw, such as by applying a tool to the bond before applying the energy.

In this way, in accordance with this invention, then, the highly polished, high quality optic surface provided by the nanolaminate 112 removed from mandrel 110 provides a very high quality optic, while the substrate 114 provides the required stiffness and if made hollow with very little weight. Further, a number of such mirrors can be made easily and quickly using the same mandrel. That is, the mandrel finish will provide a high quality optical surface on the nanolaminate for many, many forming operations. In the neighborhood of 40 or 50 nanolaminates with high quality optical finishes can be made from a single mandrel before the mandrel has to be resurfaced. A substrate, with, for example, a 25 micron surface finish can have a nanolaminate of perhaps 0.2 micron finish adhered to it.

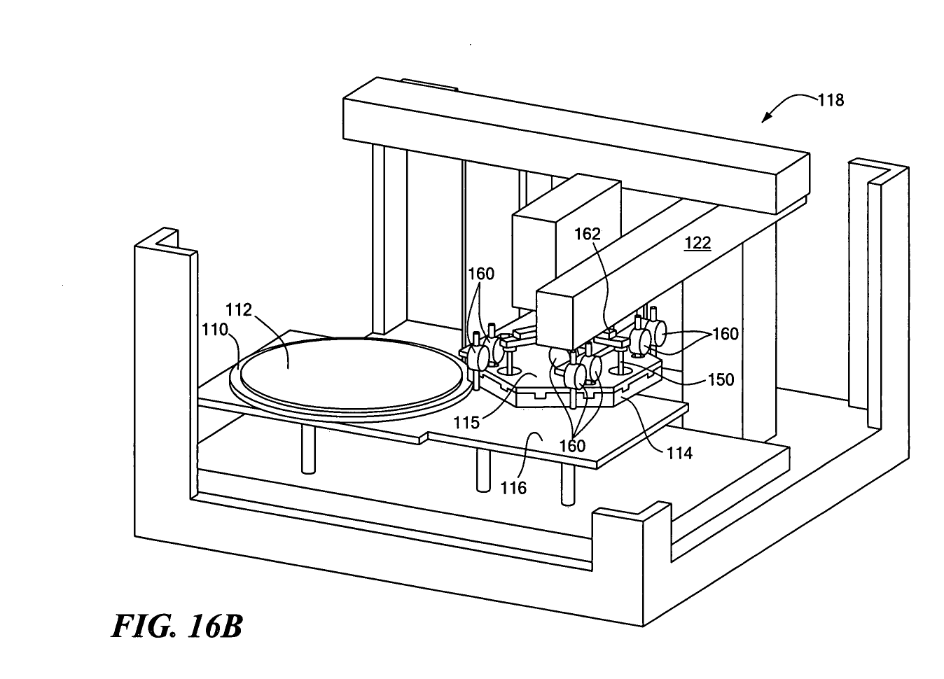

The temperature cycling of the bonded assembly 120 is depicted in FIG. 10, where it can be seen that the mandrel and nanolaminate remain generally at room temperature as shown at 130 right through the initial bonding at 132. After a three day cure, 134, the temperature is raised to approximately room temperature to 50° C. as at 36 to further cure the epoxy adhesive. The bonded assembly is then reduced to room temperature as at 138 and then less than a day later once again raised to approximately room temperature to 50° C. at 140. Following this the release cycle occurs wherein the bonded assembly is reduced in temperature to somewhere between room temperature and −20° C. At this point the nanolaminate releases from the mandrel due to the thermal moments induced by the temperature cycling but remains attached by the adhesive to the substrate.

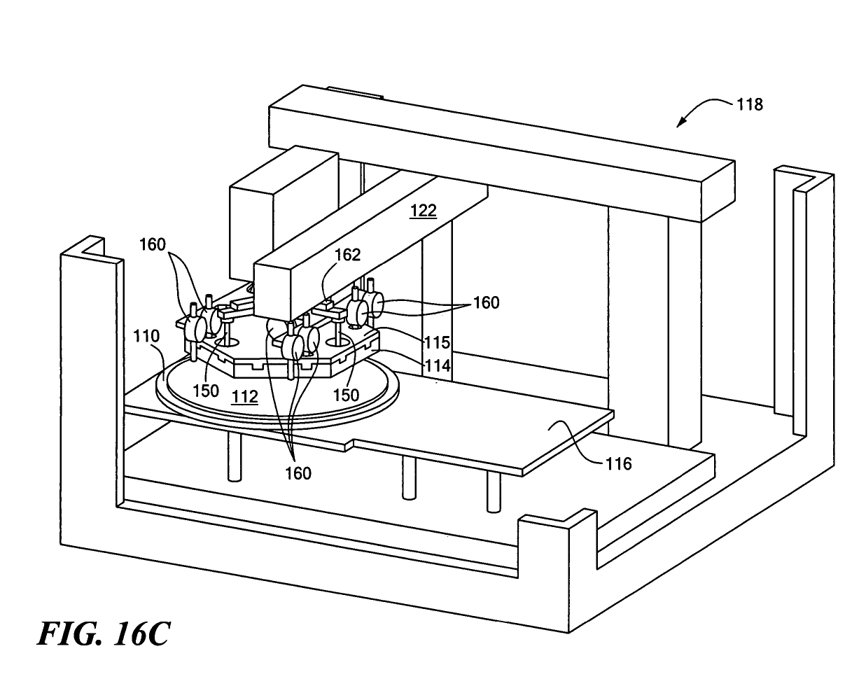

An abbreviated depiction of the steps of the method according to this invention are shown in FIGS. 11-14. Initially, FIG. 11, substrate 114 is gripped by the arm 122 of the robot machine such as for example by using holders e.g. suction cups 150. A drop of adhesive 152 is placed on nanolaminate 112 which is carried by mandrel 110. Arm 122 then brings down substrate 114, FIG. 12, to confront nanolaminate 112. Adhesive 152 is now spread out over both confronting surfaces. Typically the force applied is approximately 70 pounds by arm 122 and then a few more pounds, e.g., 10 to 20, will be added manually using small weights, for example, to bring the adhesive to a uniform gap, preferably at about 2μ. When the adhesive 152 is squeezed out to a chosen uniformity the entire bonded assembly as shown in FIG. 13 is cured, first at room temperature and then at the elevated temperature. The bonded assembly is then submitted to a cycle of temperature e.g., typically an elevated temperature followed by a reduced temperature which induces thermal moments that cause the nanolaminate 112 to release from mandrel 110, FIG. 14, but remain adhered to substrate 114.

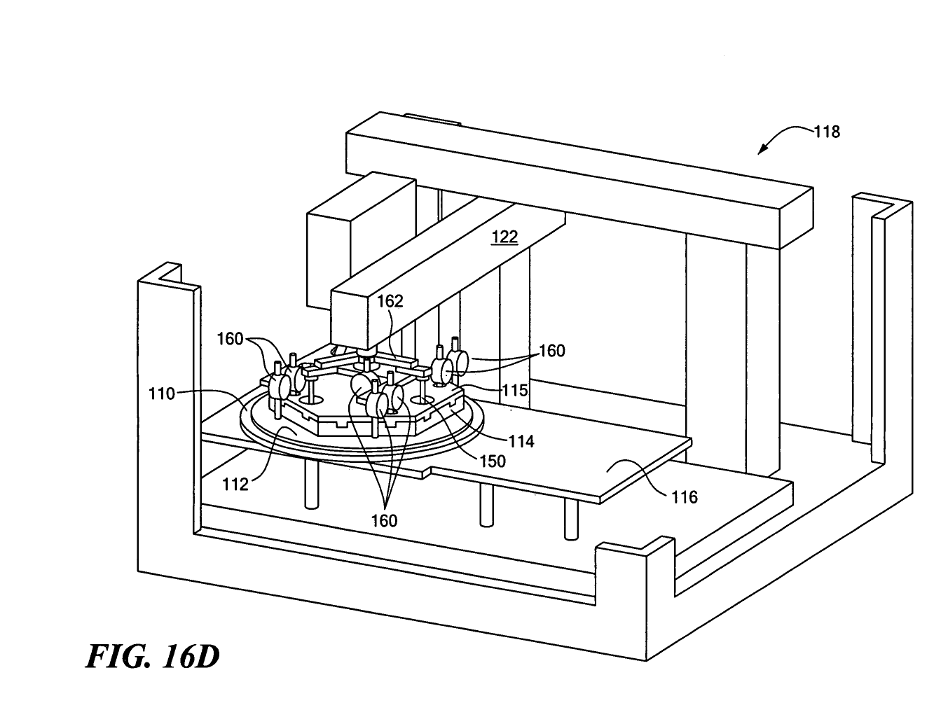

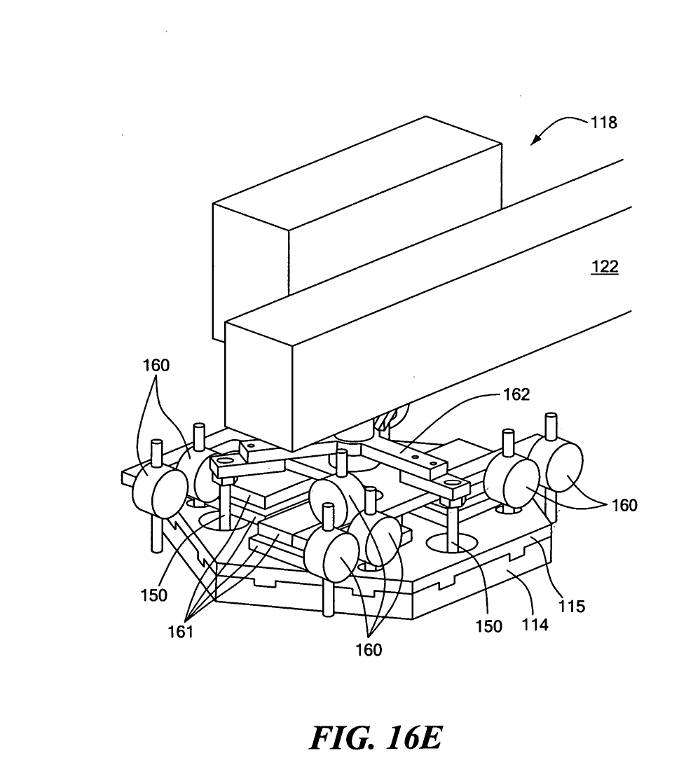

Adhesive 152, FIG. 15, performs the function of adhering nanolaminate 112 to substrate 114, but it also acts to fill and smooth the final surface of nanolaminate 112 when it is adhered to substrate 114 and released from mandrel 110. Typically substrate 114 for this method does not require a lot of final finishing. A finish, for example, of 25μ on its surface will be sufficient: contrast this with nanolaminate 112 whose finish imbued by mandrel 110 may be in the range of 0.2 microns. Were it not for the adhesive, nanolaminate 112 would approach, to some level, the roughness of substrate 114. However, adhesive 152 not only fills the gap, but creates a mitigating medium that tends to average out the roughness associated with substrate 114 and more nearly produce the smoothness inherent in nanolaminate 112. To accomplish this adhesive 152 contains particulate material, in this preferred embodiment fused silica, in the epoxy medium. The fused silica may have a size, for example, of 0.8 microns for a 2.0 micron adhesive layer and the adhesive as indicated can be a #301-2 made by Epoxy Technology, Inc. Billerica, Mass. or it can be a special adhesive 52-180-1 made by Epoxy Technology, Inc., Billerica, Mass. which already has a particulate material in it. The particular material used, whether fused silica or other, and the size of the particulate material as well as the viscosity of the epoxy as applied and the homogeneity of the mixture are all implicated in providing the smooth attachment of the nanolaminate 112 to substrate 114. Other desirable qualities of the gradient adhesive interface appear to be that it is compliant, experiences low volume change during curing, has minimal distortion and a good matching co-efficient of thermal expansion. The combination of these things in the adhesive has only been empirically achieved and will vary depending upon the roughness of the surfaces, the type of epoxy used, the gap desired, and perhaps even other parameters not yet identified. Additionally a commonly used layer, known as a parting layer, 153 is shown. This layer functions to releasably attach the nanolaminate 112 to mandrel 110. This is well known in the art and the materials that are used for this typically include carbon. The final force applied to close substrate 114 on nanolaminate 112 is guided by the use of a number of displacement dial meters 160, FIG. 16A, which may be mounted with holder 162 suspended from arm 122 not visible in FIG. 16A but visible in FIG. 16B. Arm 122, FIG. 16B, lifts substrate 114 which is shown with weighted insert 115 having holes to accommodate holders 150 and dial meters 160. Arm 122, FIG. 16C, traverses to locate substrate 114 over nanolaminate 112. Then after the adhesive is applied, arm 122 lowers, FIG. 16D, substrate 114 to nanolaminate 112. Additional weights 161, FIG. 16E, are added as indicated as necessary by dial meters 160 to produce a force on substrate 114 to result in a desired adhesive gap width and uniformity.

Although in this particular example the optic is a mirror, the invention is not limited to only that type of optic element. In accordance with this method then, by freeing the nanolaminate from the mandrel, in this way, and bonding it to a substrate there has been obtained an optical element with high strength and stiffness, low weight and a high quality optical surface finish.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A hybrid optical component comprising:
a substrate including a mounting surface; and
a replicated optical surface mounted on said mounting surface.

2. The hybrid optical component of claim 1 in which said replicated optical surface includes a nanolaminate.

3. The hybrid optical component of claim 1 in which said replicated optical surface includes glass.

4. The hybrid optical component of claim 1 in which said replicated optical surface includes Mylar film.

5. The hybrid optical component of claim 2 in which said replicated optical surface includes a nanolaminate made from zirconium-copper.

6. The hybrid optical component of claim 2 in which said replicated optical surface includes a nanolaminate made from Invar.

7. The hybrid optical component of claim 2 in which said replicated optical surface includes a nanolaminate made from Monel-titanium.

8. The hybrid optical component of claim 1 in which said substrate includes glass.

9. The hybrid optical component of claim 1 in which said substrate includes silicon carbide.

10. The hybrid optical component of claim 1 in which said substrate includes beryllium.

11. The hybrid optical component of claim 1 in which said substrate includes carbon fiber reinforced polymer.

12. The hybrid optical component of claim 1 in which said substrate includes one of the materials, metal matrix composite, glass matrix composite, and carbon matrix composite.

13. The hybrid optical component of claim 1 in which said replicated optical surface is mounted by brazing.

14. The hybrid optical component of claim 1 in which said replicated optical surface is mounted by solder.

15. The hybrid optical component of claim 1 in which said replicated optical surface is mounted by diffusion bonding.

16. The hybrid optical component of claim 1 in which said an adhesive mounts replicated optical surface.

17. The hybrid optical component of claim 1 in which said adhesive includes a polymer.

18. The hybrid optical component of claim 1 in which said adhesive includes an epoxy.

19. The hybrid optical component of claim 1 in which said adhesive includes a particulate.

20. The hybrid optical component of claim 19 in which said adhesive particulate includes fused silica.
